(19) United States
(12) Patent Application Publication
(10) Pub. No.: US 2026/0077965 A1
(43) Pub. Date: Mar. 19, 2026

(54) STORAGE DEVICE AND STORAGE UNIT

(71) Applicant: FUTABA INDUSTRIAL CO., LTD., Aichi (JP)

(72) Inventors: Keisuke YAKITA, Aichi (JP); Koichi ISHIMARU, Aichi (JP); Tatsuya KOYAMA, Aichi (JP)

(21) Appl. No.: 19/312,910

(22) Filed: Aug. 28, 2025

(30) Foreign Application Priority Data
Sep. 17, 2024 (JP) 2024-160268

(51) Int. Cl. B65G 57/04; B21D 43/20; B65G 1/16

(52) U.S. Cl. CPC B65G 57/04; B21D 43/20; B65G 1/16

(57) ABSTRACT

A storage device configured to store at least one press-formed product is provided. The storage device includes at least one arrangement portion and a placement portion. The arrangement portion is a seating including a first groove and a second groove. The first groove and the second groove are formed to intersect with each other in an X shape in plan view. The placement portion includes at least one first plate including at least one first slit and at least one second plate including at least one second slit. The first slit and the second slit cause the first plate and the second plate to be engaged with each other. The first plate and the second plate stand on the arrangement portion in a state in which the first plate is fitted in the first groove and the second plate is fitted in the second groove.

### CROSS-REFERENCE TO RELATED APPLICATIONS

This application claims the benefit of Japanese Patent Application No. 2024-160268 filed on Sep. 17, 2024 with the Japan Patent Office, the entire disclosure of which is incorporated herein by reference.

### BACKGROUND

The present disclosure relates to a storage device and a storage unit.

Utility Model Gazette No. H01-037788 describes a hanging device to be installed at a location in a final processing step to be performed by a continuous press machine such as a transfer press machine or the like. Press-formed products formed by the continuous press machine are stored on the hanging device. The press-formed products are stored while being suspended side by side, with their posture rotated by 90 degrees from the posture when press-formed.

### SUMMARY

However, in order to store the press-formed products on the hanging device, the press-formed products need to have holes formed therein to be suspended. Accordingly, there is concern that the hanging device cannot store the press-formed products that cannot have holes formed due to their structure, resulting in low versatility.

One aspect of the present disclosure is to provide a technique that can increase versatility of a storage device configured to store a press-formed product.

One aspect of the present disclosure is a storage device configured to store at least one press-formed product. The storage device comprises at least one arrangement portion and a placement portion. The at least one arrangement portion is a seating including a first groove and a second groove that are formed to intersect with each other in an X shape in plan view. The placement portion includes at least one first plate and at least one second plate and is a support member configured to support the at least one press-formed product from below. The placement portion is arranged on an upper part of the at least one arrangement portion. The at least one first plate includes at least one first slit extending in an up-down direction, and the at least one second plate includes at least one second slit extending in the up-down direction. The at least one first slit and the at least one second slit cause the at least one first plate and the at least one second plate to be engaged with each other to intersect in an X shape in plan view. The placement portion is configured to be arranged on the at least one arrangement portion to stand in a state in which the at least one first plate is fitted in the first groove and the at least one second plate is fitted in the second groove.

In such a configuration, it is possible to load the at least one press-formed product on an upper part of the placement portion. In this case, it is not necessary to deliberately perform an unnecessary processing such as making a hole in the at least one press-formed product, in order to place the at least one press-formed product on the placement portion. Thus, even if the at least one press-formed product is a product that is difficult to subject to a processing for placement on the placement portion, it is possible to store the at least one press-formed product on the storage device. Accordingly, the versatility of the storage device can be increased.

In one aspect of the present disclosure, the storage device may be configured to store the at least one press-formed product press-formed by a transfer press machine. The transfer press machine may include a transferring device configured to move the at least one press-formed product in a defined direction. The at least one press-formed product may be sequentially pressed using various press-forming dies while being moved by the transferring device in the defined direction. The storage device may be arranged adjacent to a rear end of the transferring device. The at least one press-formed product may be loaded onto the storage device from the rear end of the transferring device.

In such a configuration, it is possible to store the at least one press-formed product on the storage device just as it is from the transferring device. Accordingly, a worker does not have to carry the at least one press-formed product to a storage position, and it is possible to reduce the worker's workload, thereby improving the productivity.

In one aspect of the present disclosure, the at least one first plate may include a protruding portion protruding upward from the at least one first plate, and/or the at least one second plate may include a protruding portion protruding upward from the at least one second plate.

In such a configuration, it is possible to inhibit the at least one press-formed product supported by the placement portion from falling from the placement portion, using the protruding portion.

In one aspect of the present disclosure, the at least one first plate may include a weight-reducing hole penetrating through side surfaces of the at least one first plate, and/or the at least one second plate may include a weight-reducing hole penetrating through side surfaces of the at least one second plate.

In such a configuration, it is possible to reduce the weight of the placement portion, compared with a configuration that does not include the weight-reducing hole.

In one aspect of the present disclosure, the at least one arrangement portion may include walls between which the first groove and/or the second groove is formed. The walls may each include a first hole portion that is a hole penetrating through side surfaces of the respective walls. The at least one first plate may include a second hole portion that is a hole penetrating through side surfaces of the at least one first plate, and/or the at least one second plate may include a second hole portion that is a hole penetrating through side surfaces of the at least one second plate. The placement portion may be configured to be arranged on the at least one arrangement portion such that the first hole portion and the second hole portion face each other. The placement portion may be configured to be fixed to the at least one arrangement portion by an insertion member to be inserted to pass through the first hole portion and the second hole portion.

In such a configuration, it is possible to firmly fix the placement portion to the at least one arrangement portion. Thus, the placement portion can stably support the at least one press-formed product.

In one aspect of the present disclosure, a shape of a ridge line of an upper end of each of the at least one first plate and the at least one second plate may follow a shape of a lower surface of the at least one press-formed product.

In such a configuration, the storage device allows the at least one press-formed products to be stacked in their posture when press-formed. Thus, the storage device allows the at least one press-formed products to be stacked more stably.

One aspect of the present disclosure may be a storage unit that comprises an adhesion device configured to carry at least one press-formed product by releasably adhering to an upper surface of the at least one press-formed product, and a storage device configured to store the at least one press-formed product. The storage device includes at least one arrangement portion and a placement portion. The at least one arrangement portion is a seating including a first groove and a second groove are formed to intersect with each other in an X shape in plan view. The placement portion includes at least one first plate and at least one second plate and is a support member configured to support the at least one press-formed product from below. The placement portion is arranged on an upper part of the at least one arrangement portion. The at least one first plate includes at least one first slit extending in an up-down direction, and the at least one second plate includes at least one second slit in the up-down direction. The at least one first slit and the at least one second slit cause the at least one first plate and the at least one second plate to be engaged with each other to intersect in an X shape in plan view. The placement portion is configured to be arranged on the at least one arrangement portion to stand in a state in which the at least one first plate is fitted in the first groove and the at least one second plate is fitted in the second groove. The adhesion device is configured to load the at least one press-formed product adhered thereto onto the storage device.

In such a configuration, it is possible to utilize the adhesion device to load the at least one press-formed product on an upper part of the placement portion. In this case, it is not necessary to perform a processing such as making a hole in the at least one press-formed product, in order to place the at least one press-formed product on the placement portion. Thus, even if the at least one press-formed product is a product that is difficult to subject to a processing for placement on the placement portion, it is possible to store the at least one press-formed product on the storage device. Accordingly, the versatility of the storage device can be increased.

### BRIEF DESCRIPTION OF THE DRAWINGS

Hereinafter, example embodiments of the present disclosure will be described below with reference to the accompanying drawings, in which:

FIG. 1 is a perspective view showing a storage device, prior to arrangement of a placement portion on arrangement portions;

FIG. 2A is a perspective view showing the storage device when the placement portion is arranged on the arrangement portions;

FIG. 2B is a perspective view showing the storage device when objects are stored;

FIG. 3A is a perspective view of a state in which an object is placed on the placement portion, with portion of a rear part thereof being omitted;

FIG. 3B is a rear view of the placement portion, showing its front part forward of a second plate located at a rear;

FIG. 4A is a perspective view of the placement portion, showing its front part forward of a second plate positioned at a front;

FIG. 4B is a rear view of the placement portion, showing the front part forward of the second plate located at the front;

FIG. 5A is a perspective view of the placement portion, showing its left part leftward of a first plate;

FIG. 5B is a side view of the placement portion, showing a left part leftward of the first plate;

FIG. 6 is a diagram illustrating a mode of use of the storage device;

FIG. 7 is a schematic diagram of a storage unit;

FIG. 8A is a perspective view of a placement portion of a first modified example in a state in which an object is placed on the placement portion, with rear part thereof being partially omitted;

FIG. 8B is a rear view of the placement portion of the first modified example, showing a front part thereof forward of a second plate located at the rear;

FIG. 9A is a perspective view of the placement portion of the first modified example, showing the front part thereof forward of the second plate located at the front;

FIG. 9B is a rear view of the placement portion of the first modified example, showing the front part forward of the second plate located at the front;

FIG. 10A is a perspective view of the placement portion of the first modified example, showing a left part thereof leftward of a first plate;

FIG. 10B is a side view of the placement portion of the first modified example, showing the left part leftward of the first plate; and

FIG. 11 is a side view of a first plate of a second modified example.

### DETAILED DESCRIPTION OF EXEMPLARY EMBODIMENTS

### 1. First Embodiment

### [1-1. Configuration]

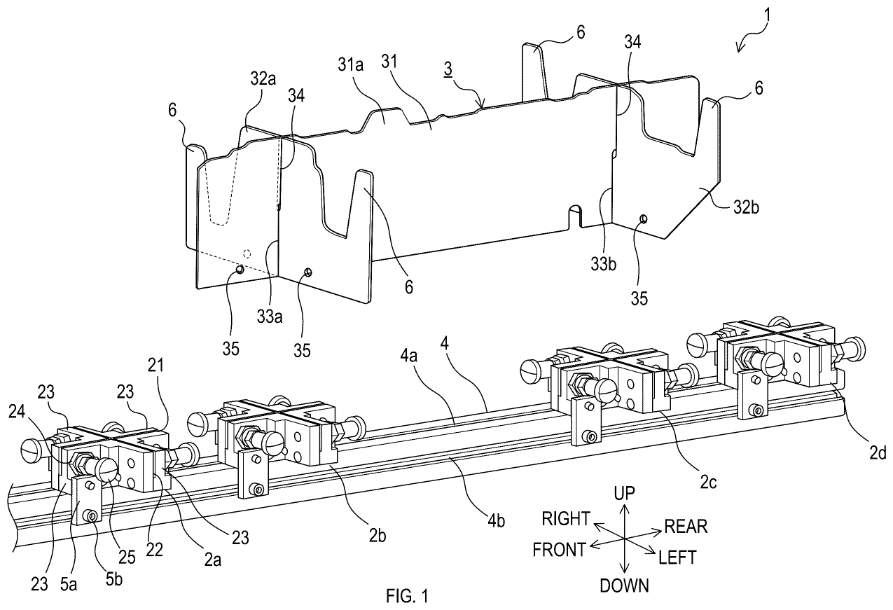

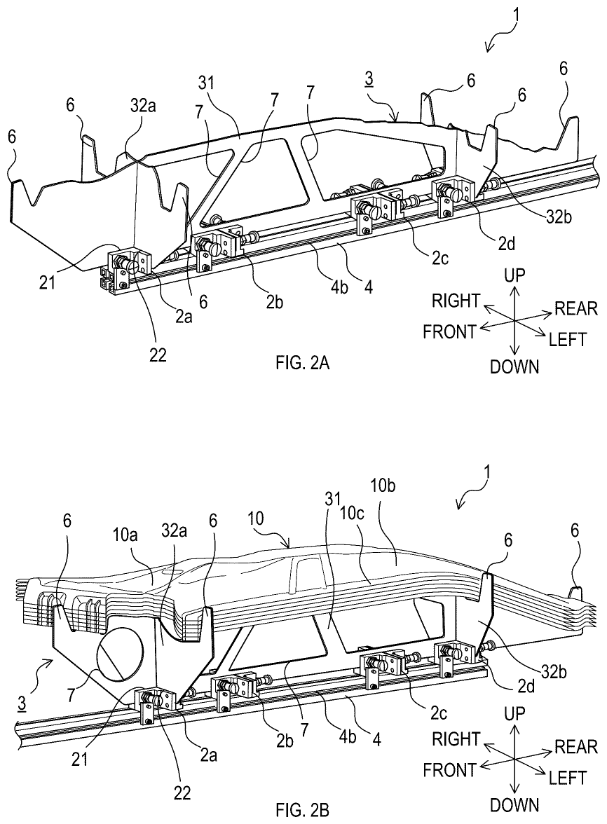

A storage device 1 as shown in FIGS. 1, 2A, and 2B is a jig for storing at least one press-formed product 10. In one example, the press-formed product 10 is used as a center-pillar to be mounted in a vehicle. Hereinafter, a longitudinal direction of a first plate 31, which will be described below, is referred to as a front-rear direction. A longitudinal direction of second plates 32a and 32b, which will be described below, is referred to as a left-right direction. A direction in which the first plate 31 and the second plates 32a and 32b are erected is referred to as an up-down direction. It is noted that these directions are defined for the sake of explanation and do not limit a mode of use of the storage device 1.

As shown in FIG. 2B, the press-formed product 10 comprises a top plate portion 10a, vertical wall portions 10b, and flange portions 10c. The top plate portion 10a has a plate shape and includes a front part flared substantially in a single plane and a rear part extending downward in a sloping manner. A width of the front part of the top plate portion 10a in the left-right direction is greater than a width of a rear part of the top plate portion 10a in the left-right direction. Each of the vertical wall portions 10b has a plate shape and extends substantially downward from a corresponding one of a left end and a right end of the top plate portion 10a. Each of the flange portions 10c has a plate shape and protrudes in a direction intersecting with the corresponding vertical wall portion 10b from an end thereof opposite to a portion in which the vertical wall portion 10b and the top plate portion 10a are connected to each other. Each of the flange portions 10c protrudes toward a side opposite to the direction in which the top plate portion 10a extends relative to the corresponding vertical wall portion 10b. The press-formed product 10 has a substantially U-shape in a cross-section orthogonal to the front-rear direction.

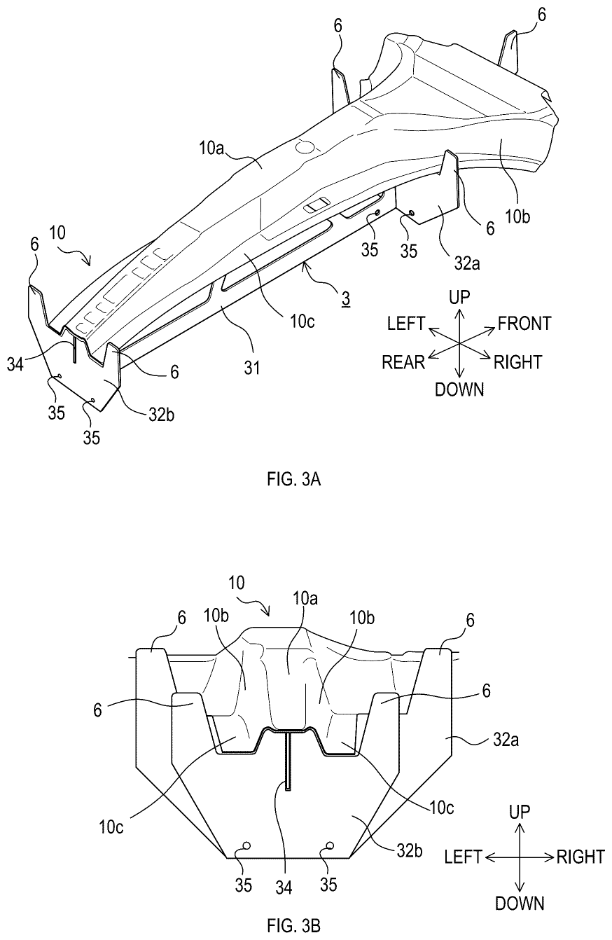

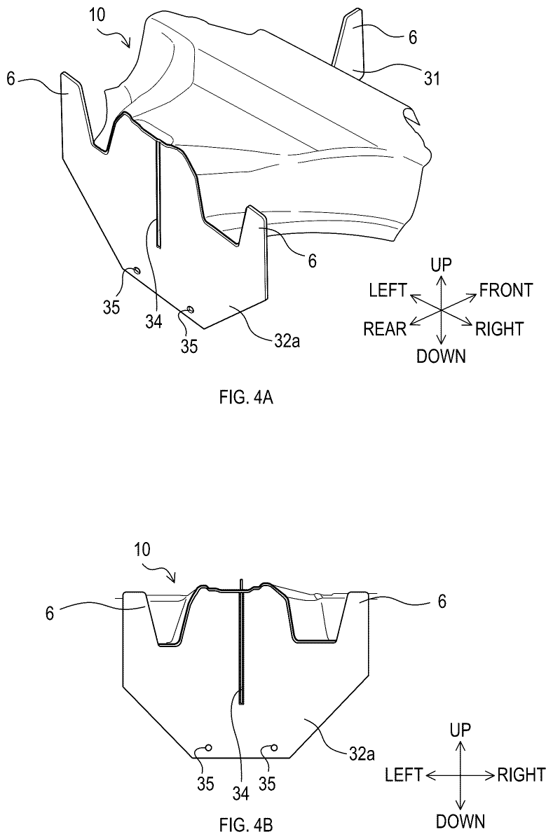

As shown in FIG. 1, the storage device 1 comprises four arrangement portions 2a, 2b, 2c, and 2d and a placement portion 3. Hereinafter, the “four arrangement portions 2a, 2b, 2c, and 2d” may be simply referred to as “four arrangement portions 2” or an “arrangement portion 2”. The four arrangement portions 2 will be explained with reference to FIG. 1, and the placement portion 3 will be explained with reference to FIGS. 2A, 2B, 3A, 3B, 4A, 4B, 5A, and 5B.

The four arrangement portions 2 are seatings for supporting the placement portion 3. The four arrangement portions 2 are attached to a rail 4, for example. The rail 4 is a pillar-like member extending in the front-rear direction. Grooves 4a and 4b extending in the front-rear direction are respectively provided on an upper surface and side surfaces of the rail 4.

Each of the four arrangement portions 2 has a first groove 21 and a second groove 22. The first groove 21 and the second groove 22 intersect in an X shape in plan view. More specifically, the first groove 21 and the second groove 22 intersect to form an angle of substantially 90 degrees in plan view. In other words, the first groove 21 extends in the front-rear direction, and the second groove 22 extends in the left-right direction.

The first groove 21 and the second groove 22 are formed by four vertical walls 23. The four vertical walls 23 each have a substantially L shape in plan view. The four vertical walls 23 are arranged such that their L-shaped corner portions, that is, the sides that form projecting portions face each other. Each vertical wall 23 includes a first hole portion 24, which is a hole penetrating through side surfaces of the vertical wall 23.

The arrangement portion 2 has a positioning mechanism for fixing the arrangement portion 2 at a specified position on the rail 4. The positioning mechanism comprises a plate 5a and a pin 5b. The plate 5a is a rectangular plate. An upper part of the plate 5a is coupled to a lower part of a corresponding one of the vertical walls 23. In a lower part of the plate 5a, an insertion hole penetrating the plate 5a is formed. A leading end of the pin 5b is inserted into the groove 4b from the insertion hole, and the leading end of the pin 5b and the groove 4b are in contact with each other, thereby fixing the plate 5a to the rail 4. The pin 5b is an index plunger, for example. The arrangement portion 2 is detachable from the rail 4 when the pin 5b is withdrawn from the groove 4b.

The placement portion 3 is a support member for supporting the press-formed product 10 from below. The placement portion 3 includes the first plate 31 and the two second plates 32a and 32b. The placement portion 3 is arranged on an upper part of the arrangement portion 2.

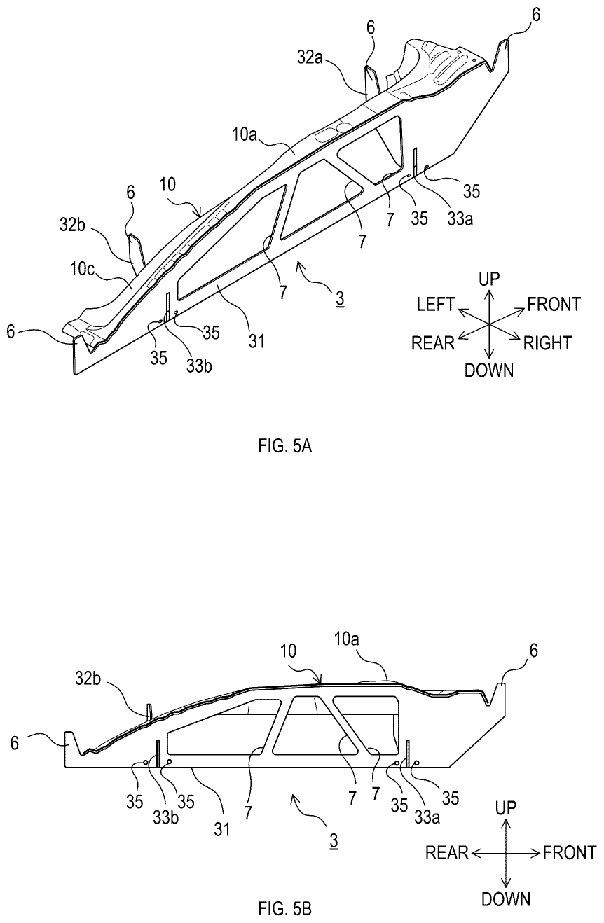

The first plate 31 is a plate-shaped metal member. As shown in FIGS. 5A and 5B, a shape of a ridge line of a lower end of the first plate 31 (shape tranced along an edge) is a substantially straight line. A shape of a ridge line of an upper end of the first plate 31 follows a shape of a lower surface of the press-formed product 10. More specifically, the shape of the ridge line of the upper end of the first plate 31 follows a shape passing through a center in the left-right direction on a lower surface of the top plate portion 10a of the press-formed product 10. In other words, the shape of the ridge line of the upper end of the first plate 31 is substantially the same as a sectional shape of the press-formed product 10 orthogonal to the left-right direction. Specifically, a front part of the ridge line extends substantially linearly, and a rear part of the ridge line extends downward in a sloping manner.

Protruding portions 6 that are portions protruding upward are provided at a front end and a rear end of the first plate 31. Each of the protruding portions 6 is formed in a sloping manner such that the ridge line on a side close to the press-formed product 10 is closer to the press-formed product 10 as the ridge line extends downward.

The first plate 31 includes two first slits 33a and 33b each extending in the up-down direction. The two first slits 33a and 33b each extend from the lower end of the first plate 31 to substantially the center of the first plate 31 in the up-down direction. The first slit 33a is provided forward of the center of the first plate 31 in the front-rear direction. The first slit 33b is provided rearward of the center of the first plate 31 in the front-rear direction.

The first plate 31 includes weight-reducing holes 7, which are holes each penetrating through side surfaces of the first plate 31. The weight-reducing holes 7 are provided between the first slit 33a and the first slit 33b. The weight-reducing holes 7 may be provided forward of the first slit 33a, or may be provided rearward of the first slit 33b. The shape of each of the weight-reducing holes 7 is not limited and may be a substantially polygonal shape or a substantially circular shape, for example. The weight-reducing holes 7 are simply holes that contribute to reducing the weight of the member. No component is inserted into the weight-reducing holes 7.

The first plate 31 includes second hole portions 35, which are holes each penetrating through the side surfaces of the first plate 31. The second hole portions 35 are provided in the vicinity of the lower end of the first plate 31 and near the first slits 33a and 33b such that each of the first slits 33a and 33b is located between corresponding ones of the second hole portions 35.

The second plates 32a and 32b are plate-shaped metal members. A shape of a ridge line of a lower end of each of the second plates 32a and 32b is a substantially straight line. As shown in FIGS. 2A, 3A, 3B, 4A, 4B, 5A, and 5B, a shape of a ridge line of an upper end of each of the second plates 32a and 32b follows the shape of the lower surface of the press-formed product 10. More specifically, the shape of the ridge line of the upper end of each of the second plates 32a and 32b is substantially the same as the shape of the cross section of the press-formed product 10 at a specified location orthogonal to the front-rear direction. Specifically, in a portion of each of the second plates 32a and 32b to be in contact with the top plate portion 10a, the ridge line extending in a substantially horizontal direction is formed. In a portion of each of the second plates 32a and 32b to in contact with the vertical wall portions 10b, the ridge line extending in a substantially vertical direction is formed. In a portion of each of the second plates 32a and 32b to be in contact with the flange portions 10c, the ridge line extending in the substantially horizontal direction is formed. A length of the second plate 32a in the left-right direction is longer than a length of the second plate 32b in the left-right direction. Also, a length of the second plate 32a in the up-down direction is longer than a length of the second plate 32b in the up-down direction.

At a right end and a left end of each of the second plates 32a and 32b, the respective protruding portions 6, which are portions protruding upward, are provided. In other words, each of the second plates 32a and 32b has a shape in which a center part in the left-right direction and the left and right ends relatively protrude. Each of the protruding portions 6 is formed in a sloping manner such that the ridge line of each protruding portion 6 on the side close to the press-formed product 10 is closer to the press-formed product 10 as the ridge line extends downward. The ridge line of an upper side of each of the protruding portions 6 provided on the second plate 32a has substantially the same height as that of the portion of the second plate 32a to be in contact with the top plate portion 10a. The ridge line of the upper side of each of the protruding portions 6 provided on the second plate 32b is provided at a higher position than that of the portion of the second plate 32b to be in contact with the top plate portion 10a.

Each of the second plates 32a and 32b includes a second slit 34 extending in the up-down direction. The second slit 34 extends from an upper end of each of the second plates 32a and 32b to substantially the center of each of the second plates 32a and 32b in the up-down direction. The second slit 34 is provided at substantially the center of each of the second plates 32a and 32b in the left-right direction.

Each of the second plates 32a and 32b includes second hole portions 35, which are holes each penetrating through side surfaces of each of the second plates 32a and 32b. The second hole portions 35 are provided in the vicinity of a lower end of each of the second plates 32a and 32b.

The first slit 33a and the second slit 34 of the second plate 32a cause the first plate 31 and the second plate 32a to be engaged with each other to intersect in an X shape in plan view. More specifically, in a position where the first slit 33a and the second slit 34 of the second plate 32a are on a substantially straight line in the up-down direction, the first plate 31 is moved downward from above and inserted into the second slit 34 of the second plate 32a. Until an upper end of the first slit 33a is in contact with a lower end of the second slit 34, the first plate 31 is inserted into the second slit 34 of the second plate 32a. When the upper end of the first slit 33a and the lower end of the second slit 34 are in contact with each other, the lower end of the first plate 31 and the lower end of the second plate 32a are in substantially the same plane.

The first slit 33b and the second slit 34 of the second plate 32b cause the first plate 31 and the second plate 32b to be engaged with each other to intersect in an X shape in plan view. More specifically, in a position where the first slit 33b and the second slit 34 of the second plate 32b are on a substantially straight line in the up-down direction, the first plate 31 is moved downward from above and inserted into the second slit 34 of the second plate 32b. Until an upper end of the first slit 33b and the lower end of the second slit 34 are in contact with each other, the first plate 31 is inserted into the second slit 34 of the second plate 32b. When the upper end of the first slit 33b and the lower end of the second slit 34 are in contact with each other, the lower end of the first plate 31 and the lower end of the second plate 32b are in substantially the same plane.

As shown in FIGS. 2A and 2B, the placement portion 3 is arranged on the arrangement portion 2 to stand in a state in which the first plate 31 is fitted in the first groove 21 and the second plates 32a and 32b are fitted in the respective second grooves 22. More specifically, the first plate 31 is fitted in the first grooves 21 of the four arrangement portions 2a, 2b, 2c, and 2d. The second plate 32a is fitted in the second groove 22 in the arrangement portion 2a. The second plate 32b is fitted in the second groove 22 in the arrangement portion 2d.

The placement portion 3 is arranged on the arrangement portion 2 such that the first hole portion 24 and the second hole portion 35 face each other. The placement portion 3 is fixed to the arrangement portion 2 by an insertion member 25 to be inserted to penetrate through the first hole portion 24 and the second hole portion 35. The insertion member 25 is a bolt, for example.

### [1-2. Mode of Use]

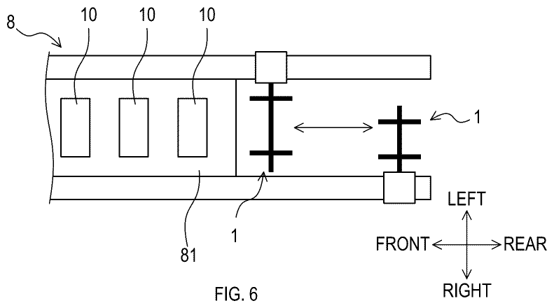

Next, situations in which the storage device 1 is used will be explained with reference to FIG. 6.

In one example, the storage device 1 stores the press-formed product 10, which is press-formed by a transfer press machine 8. Also, in the present mode of use, two rails 4 are used. To each of the two rails 4, a corresponding storage device 1 is attached. Each of the two rails 4 is configured such that its height in the up-down direction and its position in the front-rear direction, together with the storage device 1 attached thereto, are adjusted.

The transfer press machine 8 is an apparatus that performs various press-forming processing steps on a workpiece while transferring the workpiece. In each of the processing steps, a different press-forming die is used.

The transfer press machine 8 includes a transferring device 81 that moves the press-formed product 10 in a defined direction (for example, in the front-rear direction). The press-formed product 10 is sequentially pressed while being moved by the transferring device 81 in the defined direction. In other words, the press-formed product 10 is sequentially pressed using various press-forming dies while being transferred by the transferring device 81.

One storage device 1 of two storage devices 1 is arranged adjacent to a rear end of the transferring device 81. Specifically, the one storage device 1 is arranged adjacent to a position where the final press-forming processing step is performed. In other words, one rail 4 of the two rails 4 is in a standby state at a position adjacent to the rear end of the transferring device 81. The other storage device 1 of the two storage devices 1 is arranged at a position spaced apart from the transferring device 81. In other words, the other rail 4 of the two rails 4 is in a standby state at a position spaced apart from the transferring device 81.

The press-formed product 10 is loaded just as it is onto the storage device 1 from the rear end of the transferring device 81. Specifically, the storage device 1 stores the press-formed product 10 pushed out from the rear end of the transferring device 81.

When a specific number of press-formed products 10 are stored on the storage device 1, the one rail 4 is moved to be spaced away from the transferring device 81. At this time, the other storage device 1, which is arranged at the position apart from the transferring device 81, is moved to approach the rear end of the transferring device 81. In other words, the other rail 4 is moved to approach the rear end of the transferring device 81. It is to be noted that a worker adjusts the heights of the two rails 4 in the up-down direction in advance so that the two rails 4 can pass each other at a distance in the up-down direction.

The press-formed product 10 stored on the storage device 1 is transferred to a specified location by, for example, a transporting device for holding and transporting the press-formed product 10.

### [1-3. Effects]

The above-detailed first embodiment provides effects described below.
(1a) The storage device 1 comprises the arrangement portion 2 and the placement portion 3. The placement portion 3 supports the press-formed product 10 from below. In such a configuration, it is possible to load the press-formed product 10 on an upper part of the placement portion 3. In this case, it is not necessary to deliberately perform an unnecessary processing such as making a hole in the press-formed product 10, in order to place it on the placement portion 3. Thus, even if the press-formed product 10 is a product that is difficult to subject to a processing for placement on the placement portion 3, it is possible to store the press-formed product 10 on the storage device 1. Accordingly, the versatility of the storage device 1 can be increased.
(1b) The arrangement portion 2 includes the first groove 21 and the second grooves 22. The first groove 21 and the second groove 22 are arranged to intersect with each other in an X shape in plan view. In such a configuration, it is easier to stably fix the first plate 31 and the second plates 32a and 32b through the first groove 21 and the second groove 22, compared with a configuration that includes either the first groove 21 or the second groove 22. This makes it possible to support the press-formed product 10 more stably.
(1c) Each of the first slits 33a and 33b and a corresponding one of the second slits 34 cause the first plate 31 and each of the second plates 32a and 32b to be engaged with each other to intersect in an X shape in plan view. In such a configuration, when the storage device 1 is not used, it is possible to separate the first plate 31 and each of the second plates 32a and 32b from each other and store the first plate 31 and the second plates 32a and 32b in a stacked manner. This enables reduction in a storage space for the storage device 1.
(1d) The storage device 1 stores the press-formed product 10, which is press-formed by the transfer press machine 8, and the press-formed product 10 is loaded onto the storage device 1 from the rear end of the transferring device 81. Conventionally, the press-formed products 10 press-formed by the transfer press machine 8 are dropped and discharged to a conveyor, and workers carry the press-formed products 10 from the conveyor to a storage position, and when the press-formed products 10 are dropped onto the conveyor, the press-formed products 10 are often placed in various posture states. However, in the aforementioned configuration, it is possible to store the press-formed products 10 on the storage device 1 just as they are from the transferring device 81. Accordingly, since the workers'workload can be reduced, it is possible to improve the productivity. In addition, since the postures of the press-formed products 10 are more likely to be kept uniform, compared with the case in which the press-formed products 10 are dropped onto the conveyor, it is easier to stack the press-formed products 10.
(1e) The first plate 31 and the second plates 32a and 32b comprise the protruding portions 6. Specifically, at the front end and the rear end of the first plate 31, the respective protruding portions 6 are provided. In such a configuration, it is possible to inhibit the press-formed product 10 placed on the first plate 31 from moving in the front-rear direction.

Furthermore, at the right end and the left end of each of the second plates 32a and 32b, the respective protruding portions 6 are provided. In such a configuration, it is possible to inhibit the press-formed product 10 placed on the second plates 32a and 32b from moving in the left-right direction. Thus, it is possible to inhibit the press-formed product 10 supported by the placement portion 3 from falling from the placement portion 3.

In addition, it is possible to use each of the protruding portions 6 as a guide for a position to place the press-formed product 10. The first plate 31 does not necessarily have to comprise the protruding portions 6, or may comprise the protruding portion 6 only at either the front end or the rear end. The second plates 32a and 32b do not necessarily have to comprise the protruding portions 6, or may comprise the protruding portion 6 only at either the right end or the left end. Even in any of configurations, it is possible to inhibit the press-formed product 10 from falling onto a side where the protruding portion 6 is provided.

Each of the protruding portions 6 is formed in a sloping manner such that the ridge line of each protruding portion 6 on the side close to the press-formed product 10 is closer to the press-formed product 10 as the ridge line extends downward. In such a configuration, when the press-formed product 10 is loaded onto the storage device 1, even if the press-formed product 10 is slightly displaced from a desired location, the press-formed product 10 slides along the sloped surface, thereby making it easier to place the press-formed product 10 on the desired location.
(1f) The first plate 31 includes the weight-reducing holes 7. In such a configuration, it is possible to reduce the weight of the placement portion 3, compared with a configuration that does not include the weight-reducing holes 7.
(1g) The storage device 1 includes the first hole portions 24 and the second hole portions 35, and the placement portion 3 is fixed to the arrangement portion 2 by the insertion members 25. In such a configuration, it is possible to firmly fix the placement portion 3 to the arrangement portion 2. Thus, the placement portion 3 can stably support the press-formed product 10.
(1h) The shape of the ridge line of the upper end of each of the first plate 31 and the second plates 32a and 32b follows the shape of the lower surface of the press-formed product 10. If the storage device 1 is configured to cause the press-formed product 10 to be placed while being in contact only with the flange portion 10c, a contact area between the storage device 1 and the press-formed product 10 is small, and therefore the pressure is unevenly applied to a contact portion of the storage device 1 in contact with the press-formed product 10. Thus, the contact portion of the storage device 1 in contact with the press-formed product 10 is likely to be worn. However, in the aforementioned configuration, since the storage device 1 is in contact with the press-formed product 10 along the shape of the press-formed product 10, it is possible to inhibit the pressure received from the press-formed product 10 from being unevenly applied. Thus, it is possible to inhibit the storage device 1 from being worn.

Furthermore, it is possible to stack the press-formed products 10 in their posture when press-formed. Thus, in addition to not having to change the postures of the press-formed products 10 in order to be stored on the storage device 1, it is possible to stack the press-formed products 10 more stably. When the press-formed products 10 can be stably stacked, it is easier to stably transport the press-formed products 10 from the storage device 1 to a specified location by the transporting device for holding and transporting the press-formed products 10.

### 2. Second Embodiment

### [2-1. Configuration]

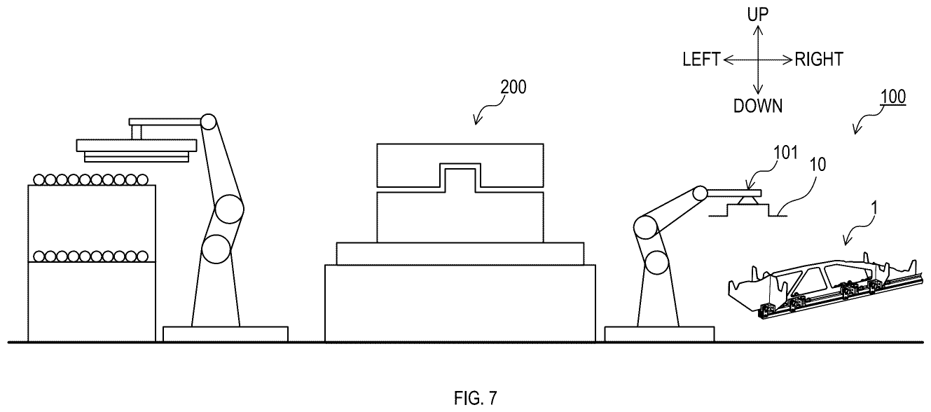

A storage unit 100 as shown in FIG. 7 is a unit including an adhesion device 101 and the storage device 1 of the first embodiment. The adhesion device 101 is a device for carrying the press-formed product 10 by releasably adhering to an upper surface of the press-formed product 10. The adhesion device 101 can move the press-formed product 10 from where it is located to the storage device 1 by a robotic arm. The adhesion device 101 may be configured to adhere to the press-formed product 10 using magnetic force, or adhere to the press-formed product 10 by suctioning the press-formed product 10 using air pressure.

The adhesion device 101 loads the press-formed product 10 adhered thereto onto the storage device 1.

### [2-2. Effects]

The above-detailed second embodiment provides effects described below, in addition to the effects of the first embodiment.
(2a) The storage unit 100 comprises the adhesion device 101 and the storage device 1. In such a configuration, even in a case in which the press-formed product 10 is press-formed without being transferred by the transferring device 81 and, it is possible to store the press-formed product 10 on the storage device 1. Therefore, it is possible to increase the versatility of the storage device 1. For example, the adhesion device 101 can releasably adhere to the press-formed product 10 carried by a conveyor and place the press-formed product 10 on the storage device 1.

For example, the storage unit 100 may be used in conjunction with a hot stamping line 200 as shown in FIG. 7. The hot stamping line 200 is an apparatus that press-forms workpieces while heating the workpieces. The adhesion device 101 may be used when the press-formed product 10, which has been press-formed, is removed therefrom.

Alternatively, for example, the storage unit 100 may be used in conjunction with a line pacer. The line pacer is an apparatus that sequentially performs press-forming by press machines arranged in series. The adhesion device 101 may be arranged adjacent to a press machine that performs a final processing step.

Alternatively, for example, the storage unit 100 may be used in conjunction with a hot stamping laser line. The hot stamping laser line is an apparatus that performs a process of press-forming workpieces while heating the workpieces and a process of applying laser processing to the press-formed product 10. The adhesion device 101 may be used to carry the press-formed product 10 subjected to the press-forming and the laser processing.

### 3. Other Embodiments

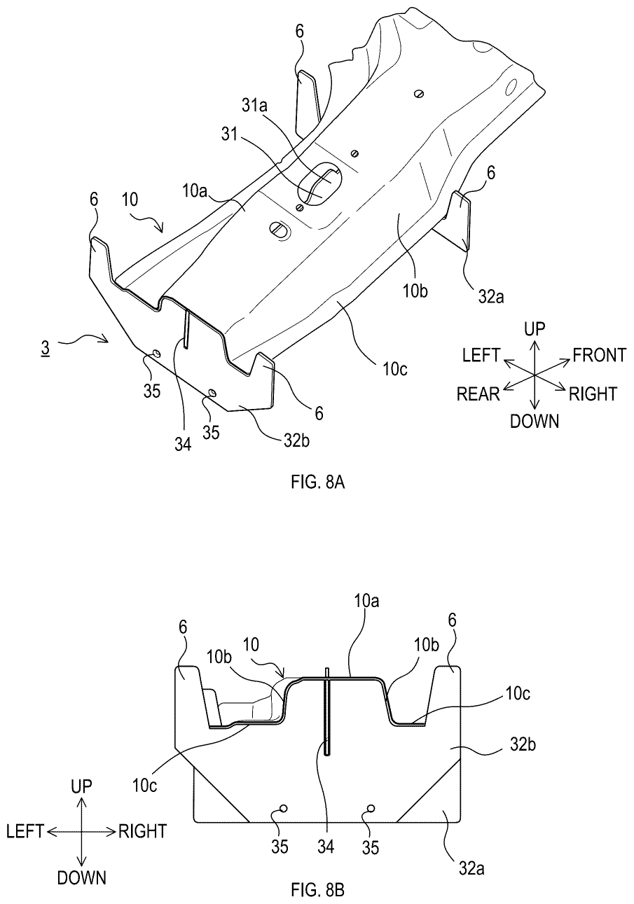

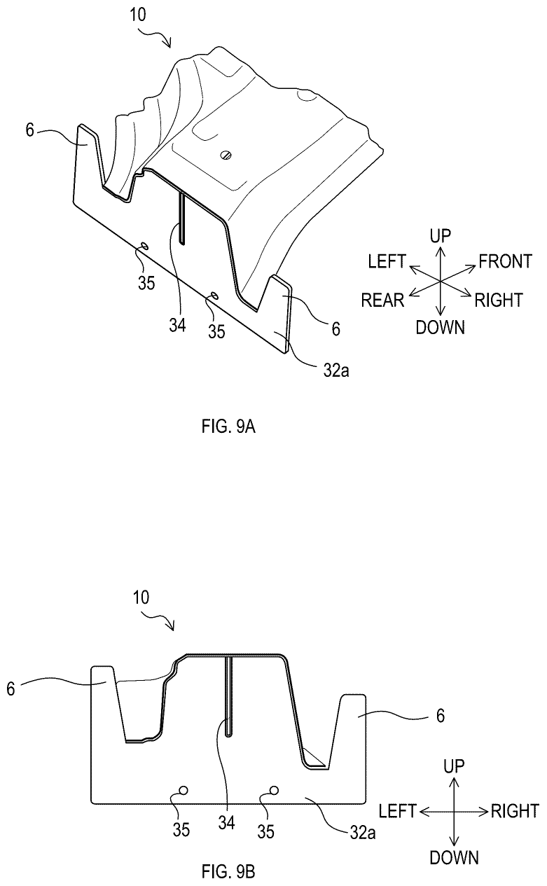

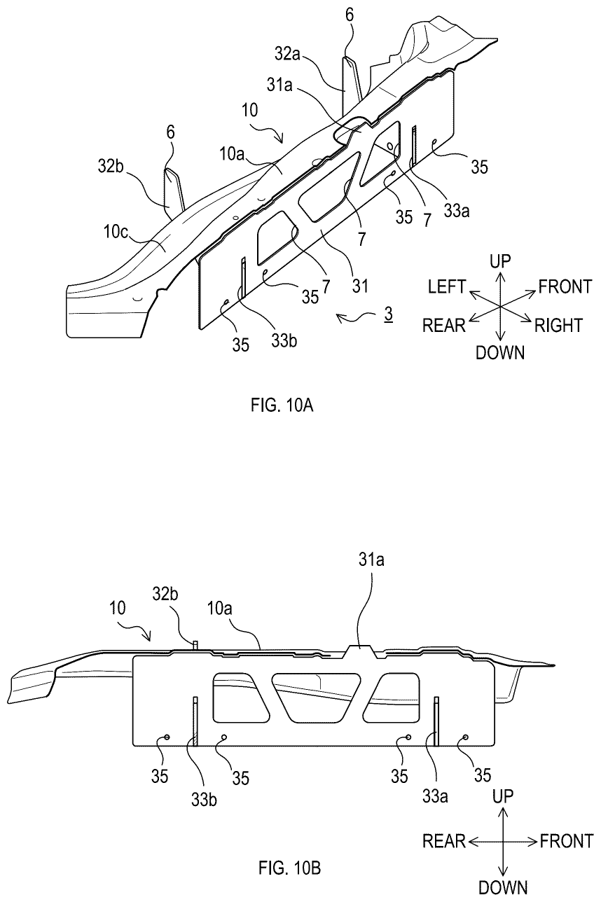

Although the above-described embodiments of the present disclosure have been described so far, it is to be understood that the present disclosure can take various forms without being limited to the above-described embodiments.
(3a) In the above-described embodiments, as an example of the press-formed product 10, the center-pillar is described. However, the type of the press-formed product 10 is not limited to this. For example, in a first modified example as shown in FIGS. 8A, 8B, 9A, 9B, 10A, and 10B, the press-formed product 10 may be a floor-cross member. The top plate portion 10a of the floor-cross member is a member having a plate shape and extending substantially in a single plane. The shape of the ridge line of the upper end of the first plate 31 may extend substantially linearly throughout. At a portion of the upper end of the first plate 31, a projecting part 31a protruding upward from the first plate 31 may be provided.

More specifically, the first plate 31 may include, at a position corresponding to a hole provided in the press-formed product 10, the projecting part 31a protruding upward from the first plate 31. In other words, the projecting part 31a is provided at substantially the same position as the position of the hole provided in the press-formed product 10 in the front-rear direction and the left-right direction when the upper end of the first plate 31 and the press-formed product 10 face each other. That is, the projecting part 31a is provided at a position allowing insertion thereof into a hole provided in the top plate portion 10a of the floor-cross member.

In such a configuration, it is possible to use the projecting part 31a as the guide to place the press-formed product 10. Also, it is possible to inhibit the position of the press-formed product 10 placed on the first plate 31 from being displaced in the front-rear direction and the left-right direction. Thus, it is possible to inhibit the press-formed product 10 supported by the placement portion 3 from falling from the placement portion 3.

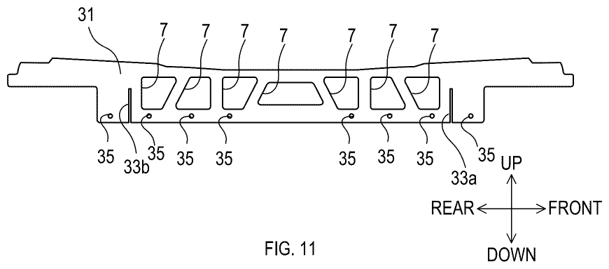

In the first modified example, the projecting part 31a also corresponds to a protruding portion. The second plates 32a and 32b may each include, at a position corresponding to a hole provided in the press-formed product 10, a projecting part protruding upward from each of the second plates 32a and 32b.
(3b) In the above-described embodiments, a configuration is described, as an example, in which the storage device 1 stores the press-formed products 10 in a state in which the press-formed products 10 are stacked in the up-down direction. However, the storage device 1 may store the press-formed products 10 in a state in which the press-formed products 10 are aligned in the front-rear direction and/or the left-right direction.
(3c) In the above-described embodiments, a configuration is described, as an example, in which the first plate 31 includes the weight-reducing holes 7. Each of the second plates 32a and 32b may also include a weight-reducing hole 7. As shown in a second modified example of FIG. 11, one or more end parts of the first plate 31 in the front-rear direction may have at least one cutout. The first plate 31 can be reduced in weight by the at least one cutout formed in the first plate 31. It is possible to reduce the weight of the first plate 31 by the cutout in the first plate 31.
(3d) In the above-described embodiments, the storage device 1 including the four arrangement portions 2 is described as an example. However, the number of the arrangement portions 2 is not limited thereto. For example, the storage device 1 may comprise one arrangement portion 2 through three arrangement portions 2, or may comprise five or more arrangement portions 2.

In the above-described embodiments, the storage device 1 including the two second plates 32a and 32b is described as an example. However, the number of the second plates is not limited thereto. For example, the storage device 1 may comprise one second plate, or may comprise three or more second plates. In other words, the first plate 31 may comprise one first slit or may comprise three or more first slits. As shown in the second modified example of FIG. 11, the first plate 31 may include second hole portions 35 spaced apart from each other.

By adjusting the number of the arrangement portions 2 or the spacing at which the arrangement portions 2 are arranged on the rail 4, it is possible to mount the placement portion 3 differing in size on the arrangement portion 2. Accordingly, when the press-formed products 10 differing in shape and/or size are stored, various placement portions 3 corresponding to these press-formed products 10 are used, but the arrangement portions 2 can be used in common.
(3e) The function of a single element in the above-described embodiments may be per-formed separately by two or more elements, and the function performed by two or more elements may be performed inclusively by a single element. Part of the configuration in the above-described embodiments may be omitted. At least part of the configuration in the above-described embodiments may be added to or replace another configuration in the above-described embodiments.

What is claimed is:

1. A storage device configured to store at least one press-formed product, the storage device comprising:
at least one arrangement portion; and
a placement portion,
the at least one arrangement portion being a seating including a first groove and a second groove, the first groove and the second groove being formed to intersect with each other in an X shape in plan view,
the placement portion including at least one first plate and at least one second plate and being a support member configured to support the at least one press-formed product from below, the placement portion being arranged on an upper part of the at least one arrangement portion,
the at least one first plate including at least one first slit extending in an up-down direction, and the at least one second plate including at least one second slit extending in the up-down direction,
the at least one first slit and the at least one second slit causing the at least one first plate and the at least one second plate to be engaged with each other to intersect in an X shape in plan view, and
the placement portion being configured to be arranged on the at least one arrangement portion to stand in a state in which the at least one first plate is fitted in the first groove and the at least one second plate is fitted in the second groove.

2. The storage device according to claim 1, wherein
the storage device is configured to store the at least one press-formed product press-formed by a transfer press machine,
the transfer press machine includes a transferring device configured to move the at least one press-formed product in a defined direction,
the at least one press-formed product is sequentially pressed using various press-forming dies while being moved by the transferring device in the defined direction,
the storage device is arranged adjacent to a rear end of the transferring device, and
the at least one press-formed product is loaded onto the storage device from the rear end of the transferring device.

3. The storage device according to claim 1, wherein
the at least one first plate includes a protruding portion protruding upward from the at least one first plate, and/or
the at least one second plate includes a protruding portion protruding upward from the at least one second plate.

4. The storage device according to claim 1, wherein
the at least one first plate includes a weight-reducing hole penetrating through side surfaces of the at least one first plate, and/or
the at least one second plate includes a weight-reducing hole penetrating through side surfaces of the at least one second plate.

5. The storage device according to claim 1, wherein
the at least one arrangement portion includes walls between which the first groove and/or the second groove is formed, the walls each including a first hole portion that is a hole penetrating through side surfaces of the respective walls,
the at least one first plate includes a second hole portion that is a hole penetrating through side surfaces of the at least one first plate, and/or the at least one second plate includes a second hole portion that is a hole penetrating through side surfaces of the at least one second plate,
the placement portion is configured to be arranged on the at least one arrangement portion such that the first hole portion and the second hole portion face each other, and
the placement portion is configured to be fixed to the at least one arrangement portion by an insertion member to be inserted to pass through the first hole portion and the second hole portion.

6. The storage device according to claim 1, wherein
a shape of a ridge line of an upper end of each of the at least one first plate and the at least one second plate follows a shape of a lower surface of the at least one press-formed product.

7. A storage unit, comprising:
an adhesion device configured to carry at least one press-formed product by releasably adhering to an upper surface of the at least one press-formed product; and
a storage device configured to store the at least one press-formed product,
the storage device including:
at least one arrangement portion; and
a placement portion,
the at least one arrangement portion being a seating including a first groove and a second groove, the first groove and the second groove being formed to intersect with each other in an X shape in plan view,
the placement portion including at least one first plate and at least one second plate and being a support member configured to support the at least one press-formed product from below, the placement portion being arranged on an upper part of the at least one arrangement portion,
the at least one first plate including at least one first slit extending in an up-down direction, and the at least one second plate including at least one second slit in the up-down direction,
the at least one first slit and the at least one second slit causing the at least one first plate and the at least one second plate to be engaged with each other to intersect in an X shape in plan view,
the placement portion being configured to be arranged on the at least one arrangement portion to stand in a state in which the at least one first plate is fitted in the first groove and the at least one second plate is fitted in the second groove, and
the adhesion device being configured to load the at least one press-formed product adhered thereto onto the storage device.
